(19) United States
(12) Patent Application Publication
(10) Pub. No.: US 2010/0302982 A1
(43) Pub. Date: Dec. 2, 2010

(54) METHOD FOR RECEIVING PACKETS AND APPARATUS FOR USING THE SAME

(75) Inventors: Chia Hsiang Hsu, HSINCHU COUNTY (TW); Tsung Yuan Pan, HSINCHU COUNTY (TW)

Correspondence Address: HAMRE, SCHUMANN, MUELLER & LARSON, P.C., P.O. BOX 2902, MINNEAPOLIS, MN, 55402-0902, US

(73) Assignee: RALINK TECHNOLOGY CORPORATION, HSINCHU COUNTY (TW)

(21) Appl. No.: 12/643,793

(22) Filed: Dec. 21, 2009

(30) Foreign Application Priority Data
Jun. 1, 2009 (TW) 098117949

(51) Int. Cl. H04W 40/00; H04W 52/02

(52) U.S. Cl. 370/311; 370/328

(57) ABSTRACT

An apparatus utilizes different channels for forwarding notification packets to at least one station and an access point. The station and the access point start or stop forwarding packets to the apparatus according to the notification packets. The station and the access point also temporarily store the packets to be forwarded to the apparatus and forward the packets to the apparatus after receiving a start notification packet from the apparatus.

### BACKGROUND OF THE INVENTION

1. Field of the Invention

The present invention relates to a communication system, and more particularly, to a method and apparatus for receiving packets.

2. Description of the Related Art

Wireless local area network (WLAN) technology is now widely used in various applications. Numerous organizations devote extensive resources to research seeking improvements in WLAN data communication quality. Recently, Bluetooth Special Interest Group (SIG) announced a next-generation Bluetooth technology called Bluetooth 3.0+HS. Bluetooth 3.0+HS is integrated with IEEE 802.11 communication protocol to improve data transmission efficiency. In an ad hoc mode network, Bluetooth 3.0+HS can increase the transmission rate to 24 Mbps.

A wireless network includes an infrastructure mode network and an ad hoc mode network. In an infrastructure mode network, a base station or an access point (AP) is needed for transmitting or receiving signals. That is, any two wireless transmit/receive units (WTRU) communicate with each other via an AP for forwarding information. In an ad hoc mode network, any two WTRUs communicate with each other directly without any assistance of a base station or an AP. However, if a WTRU forwards or receives packets in an infrastructure mode network and an ad hoc mode network at the same time, the mechanism of receiving packets is an important issue.

### SUMMARY OF THE INVENTION

A method and apparatus in accordance with the present invention utilize different channels for forwarding notification packets to at least one station and an access point. The station and the access point start or stop forwarding packets to the apparatus according to the notification packets. The station and the access point also temporarily store the packets to be forwarded to the apparatus and forward the packets to the apparatus after receiving a start notification packet from the apparatus.

One embodiment of the present invention discloses a method for receiving packets, comprising: forwarding a first stop notification packet to at least one station through a first channel; forwarding a first start notification packet to an access point through a second channel; receiving packets forwarded by the access point through the second channel; forwarding a second stop notification packet to the access point through the second channel; forwarding a second start notification packet to the at least one station through the first channel; and receiving packets forwarded by the at least one station through the first channel.

Another embodiment of the invention discloses an apparatus for receiving packets comprising a notifying unit, a switching unit, and a receiving unit. The notifying unit is utilized to forward at least one notification packet to at least one station and an AP through a first channel and a second channel, respectively. The first channel is a Bluetooth channel or a Wi-Fi channel. The second channel is a Wi-Fi channel. The notification packet is a stop notification packet or a start notification packet. The stop notification packet includes a frame control field, wherein the frame control field contains a power management bit. The stop notification packet is a clear-to-send to self (CTS-to-self) packet. The start notification packet is a Power-Save Poll (PS-Poll) packet. The switching unit is utilized to switch from the first channel to the second channel or from the second channel to the first channel. The receiving unit is utilized to receive packets forwarded by the at least one station and packets forwarded by the AP through the first channel and the second channel, respectively.

### BRIEF DESCRIPTION OF THE DRAWINGS

The invention will be described according to the appended drawings in which:

FIG. 1 shows a diagram for a wireless network in accordance with an exemplary embodiment of the present invention;

FIG. 2 shows a flowchart of receiving packets in accordance with an exemplary embodiment of the present invention; and

FIG. 3 illustrates a block diagram of an apparatus in accordance with another exemplary embodiment of the present invention.

### PREFERRED EMBODIMENT OF THE PRESENT INVENTION

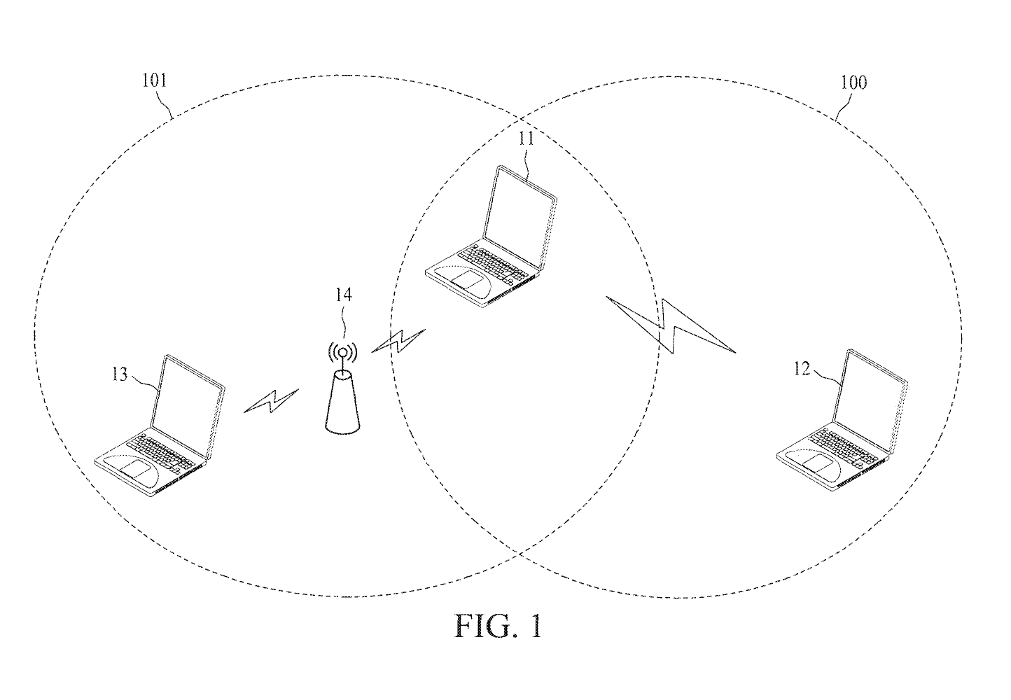

FIG. 1 shows a diagram for a wireless network in accordance with an exemplary embodiment of the present invention. The wireless network includes an ad hoc mode network 100 and an infrastructure mode network 101. The ad hoc mode network 100 includes stations 11 and 12. The infrastructure mode network 101 includes the station 11, a station 13 and an access point (AP) 14. The station 11 can directly forward packets to the station 12 or receive packets from the station 12. In the infrastructure mode network 101, the station 11 forwards packets to the station 13 through the AP 14 or receives packets from the station 13 through the AP 14. The station 11, the station 12, the station 13 and the AP 14 may all comply with IEEE 802.11 standard. The mechanism of the power-saving mode in the IEEE 802.11 standard may be applied in this embodiment. With the mechanism of the power-saving mode, the station 11 can request the station 12 or the AP 14 to stop forwarding packets by forwarding a packet to the station 12 or the AP 14. The station 12 or the AP 14 cannot forward packets to the station at any time. The packets to be forwarded are stored first, and then forwarded at a specified time. Those skilled in the art realize that the quantity of stations and APs in the above-mentioned ad hoc mode network and infrastructure mode network are not limited to the quantities shown in the above embodiment.

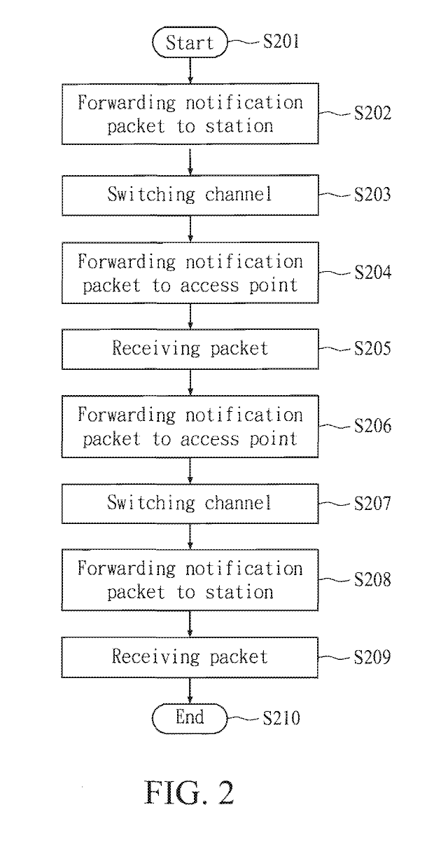

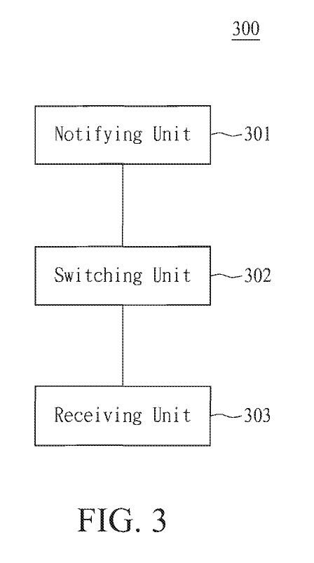

FIG. 2 shows a flowchart of a method for receiving packets in accordance with an exemplary embodiment of the present invention. In order to enable those skilled in the art to practice the present invention in accordance with the exemplary embodiment, FIG. 2 and FIG. 3 are utilized to describe the procedure of the method for receiving packets. In the exemplary embodiment, the station 11 forwards packets through a Bluetooth channel to the station 12 or receives packets through a Bluetooth channel from the station 12 while the station 11 stops communicating with the AP 14. The above-mentioned station 11 can also forward packets to the station 12 or receive packets from the station 12 through a Wi-Fi channel. In step S201, the method for receiving packets is activated. In step S202, the station 11 forwards a stop notification packet to the station 12 through the Bluetooth channel. The stop notification packet includes a frame control field, wherein the frame control field contains a power management bit. The stop notification packet can also be a CTS-to-self packet. The station 12 stops forwarding packets to the station 11 immediately after receiving the stop notification packet. When packet forwarding is stopped, packets to be forwarded to the station 11 are stored in a register of the station 12. In step S203, the station 11 switches from the Bluetooth channel to a Wi-Fi channel. The Wi-Fi channel is utilized for the station 11 and the AP 14 to communicate with each other. In step S204, the station 11 forwards a start notification packet to the AP 14 through the Wi-Fi channel. The start notification packet can be a PS-Poll packet. In step S205, the station 11 receives the packets forwarded from the AP 14. Persons skilled in the art realize that the time for receiving can be changed in accordance with a given practical application. In step S206, the station forwards a stop notification packet to the AP 14. The AP 14 stops forwarding packets to the station 11 immediately after receiving the stop notification packet. When packet forwarding is stopped, packets to be forwarded to the station 11 are stored in a register of the AP 14. In step S207, the station 11 switches from the Wi-Fi channel to the Bluetooth channel. In step S208, the station 11 forwards a start notification packet to the station 12 through the Bluetooth channel. In step S209, the station 11 receives the packets forwarded from the station 12. The procedure of the method for receiving packets can be ended in step S210, or steps S202-S209 can be repeated to receive packets in the ad hoc mode network 100 and the infrastructure mode network 101.

In addition to the above-mentioned method for receiving packets, an apparatus for receiving packets in accordance with another exemplary embodiment is described as follows to enable those skilled in the art to practice the present invention.

FIG. 3 illustrates a block diagram of an apparatus for receiving packets in accordance with another exemplary embodiment of the present invention. The packet receiving apparatus 300 comprises a notifying unit 301, a switching unit 302, and a receiving unit 303. The notifying unit 301 is utilized for forwarding at least one notification packet to at least one station and an AP through a first channel and a second channel, respectively. The first channel may be a Bluetooth channel or a Wi-Fi channel, while the second channel is a Wi-Fi channel. The notification packet is a stop notification packet or a start notification packet. The stop notification packet includes a frame control field which contains a power management bit. The stop notification packet can also be a CTS-to-self packet. In addition, the start notification packet can be a PS-Poll packet. The switching unit 302 is utilized for switching from the first channel to the second channel or switching from the second channel to the first channel. The receiving unit 303 is utilized for receiving packets forwarded from the at least one station and packets forwarded from the AP through the first channel and the second channel, respectively. The above-mentioned packet receiving apparatus 300 can be implemented with software, firmware, hardware, or a platform with a single processor or with multiple processors.

In step S202 and step S206, the notifying unit 301 is utilized for forwarding stop notification packets to the station 12 and the AP 14 through the Bluetooth channel and the Wi-Fi channel, respectively. In step S204 and step S208, the notifying unit 301 is utilized for forwarding start notification packets to the station 12 and the AP 14 through the Bluetooth channel and the Wi-Fi channel, respectively. Persons skilled in the art realize that the above-mentioned start notification packets and stop notification packets are utilized for notifying the station 12 or the AP 14 to start forwarding or to stop forwarding packets to the receiving unit 303. Therefore, packet formats of the start notification packets and the stop notification packets and the time to forward the start notification packets and the stop notification packets can be adjusted in accordance with any given practical application. In step S203 and step S207, the switching unit 302 is utilized for switching from the Bluetooth channel to the Wi-Fi channel or switching from the Wi-Fi channel to the Bluetooth channel. In step S205 and step S209, the receiving unit 303 is utilized for receiving is packets forwarded from the station 12 and packets forwarded from the AP 14 through the Bluetooth channel and the Wi-Fi channel, respectively.

The above-described embodiments of the present invention are intended to be illustrative only. Numerous alternative embodiments may be devised by those skilled in the art without departing from the scope and spirit of the present invention.

What is claimed is:

1. A method for receiving packets, comprising:
forwarding a first stop notification packet to at least one station through a first channel;
forwarding a first start notification packet to an access point through a second channel;
receiving a packet forwarded from the access point through the second channel;
forwarding a second stop notification packet to the access point through the second channel;
forwarding a second start notification packet to the at least one station through the first channel; and
receiving a packet forwarded from the at least one station through the first channel.

2. The method of claim 1, wherein the first or the second notification packet includes a frame control field.

3. The method of claim 2, wherein the frame control field contains a power management bit.

4. The method of claim 1, wherein the first and the second stop notification packets are clear-to-send to self (CTS-to-self) packets.

5. The method of claim 1, wherein the first and the second start notification packet are Power-Save Poll (PS-Poll) packets.

6. The method of claim 1, wherein the first channel is a Bluetooth channel or a Wi-Fi channel.

7. The method of claim 1, wherein the second channel is a Wi-Fi channel.

8. The method of claim 1, wherein the at least one station and the access point comply with IEEE 802.11 standard.

9. An apparatus for receiving packets, comprising:
a notifying unit configured to forward at least one notification packet to at least one station and an access point through a first channel and a second channel, respectively;
a switching unit configured to switch from the first channel to the second channel or from the second channel to the first channel; and
a receiving unit configured to receive packets forwarded from the at least one station and packets forwarded from the access point through the first channel and the second channel, respectively.

10. The apparatus of claim 9, wherein the at least one notification packet is a stop notification packet or a start notification packet.

11. The apparatus of claim 10, wherein the stop notification packet includes a frame control field.

12. The apparatus of claim 11, wherein the frame control field contains a power management bit.

13. The apparatus of claim 10, wherein the stop notification packet is a CTS-to-self packet.

14. The apparatus of claim 10, wherein the start notification packet is a PS-Poll packet.

15. The apparatus of claim 9, wherein the first channel is a Bluetooth channel or a Wi-Fi channel.

16. The apparatus of claim 9, wherein the second channel is a Wi-Fi channel.

17. The apparatus of claim 9, wherein the at least one station and the access point comply with IEEE 802.11 standard.

18. The apparatus of claim 9, which is implemented with software, firmware, hardware, or a platform with a single processor or with multiple processors.
